(19) United States
(12) Patent Application Publication
(10) Pub. No.: US 2026/0008502 A1
(43) Pub. Date: Jan. 8, 2026

(54) FRONT HINGE PILLAR REINFORCED FOR FRONTAL IMPACT WITH LOW OVERLAP

(71) Applicant: STELLANTIS AUTO SAS, Poissy (FR)

(72) Inventors: Ronan Breal, Bethoncourt (FR); Manaf Karkar, Bouskoura (MA); Vincent Higelin, Montbeliard (FR)

(21) Appl. No.: 19/125,659

(22) PCT Filed: Oct. 26, 2023
(86) PCT No.: PCT/FR2023/051687

§ 371 Date: Apr. 29, 2025

(30) Foreign Application Priority Data
Nov. 30, 2022 (FR) FR2212538

(51) Int. Cl. B62D 25/04; B62D 27/06

(52) U.S. Cl. CPC B62D 25/04; B62D 27/065

(57) ABSTRACT

The invention relates to a vehicle body (1) comprising at least one front hinge pillar (2) which partly delimits a wheel arch (3) and is made up of at least two sheet-metal parts (5) forming a rabbet (6), the sheet-metal parts (5) being joined by welding points (7) which are located on the rabbet (6), the body (1) comprising a reinforcement part (8) which is attached to the front hinge pillar (2) between the front hinge pillar (2) and a wheel, the reinforcement part (8) being designed to reinforce the front hinge pillar (2), cover a part of the front hinge pillar (2) and extend on either side of the rabbet (6) which has a plurality of projections (15) which are intended to receive the weld points (7), the reinforcement part (8) having a plurality of openings (18) which are located facing each projection (15) in order to allow each projection (15) to pass through an opening (18).

### CROSS-REFERENCE TO RELATED APPLICATIONS

This application is the US National Stage under 35 USC § 371 of International Application No. PCT/FR2023/051687, filed Oct. 26, 2023, which claims the priority of French application 2212538 filed on Nov. 30, 2022, the content (text, drawings and claims) of both said applications being incorporated by reference herein.

### BACKGROUND

The technical field relates to motor vehicle bodies comprising a reinforced front hinge pillar as well as motor vehicles featuring such a body.

When it comes to road safety, automakers must take into account a wide range of concerns and regulations when developing new vehicles. In particular, automakers must ensure the safety of vehicle passengers in the event of an impact. The behavior of motor vehicles in different crash situations is regulated and tested using standardized test procedures. The requirements in terms of test results are ever more numerous and more difficult to meet, forcing automakers to constantly innovate.

One of the standard procedures is to cause a frontal impact between the vehicle and a barrier, with the barrier impacting the vehicle only on a quarter of the side of the front bumper. Such a frontal impact is commonly referred to as a low-overlap frontal impact. Hereinafter, “frontal impact” refers more specifically to such a low-overlap frontal impact.

In the event of a low-overlap frontal impact, the front bumper cannot effectively absorb the energy released during the impact, and the wheel often swivels toward the passenger compartment, and in particular toward the front hinge pillar. The front hinge pillar is generally made up of several metal sheets joined together to form a rabbet, which is particularly susceptible to impact from the wheel during a low-overlap frontal impact. However, in the event of impact between the wheel and the rabbet, there is a significant risk that the latter will open up, thus destroying the front hinge pillar, which is then no longer able to ensure the integrity of the vehicle's passenger compartment. In order to reinforce the front hinge pillar, some vehicles feature reinforcements that are attached to the hinge pillar across the rabbet to prevent it from opening in the event of a low-overlap frontal impact. However, when the vehicle is intended to be fitted with wheels of large dimensions in relation to the wheel arches, the reinforcements normally used may prove to be limiting for the dimensions available for the wheels, or unsuitable.

Thus, there is a need for a solution that can reinforce a front hinge pillar in frontal impact situations, particularly a low-overlap frontal impact, while allowing the installation of wheels with large dimensions in relation to the wheel arches.

### SUMMARY

The object is to overcome the problems described above. In this technical context, one aim is to provide a body with at least one front hinge pillar that is reinforced against frontal impacts, in particular low-overlap frontal impacts, and accepts large wheel dimensions in relation to the dimensions of the wheel arches.

To this end, the devices described herein relate to a motor vehicle body comprising at least one front hinge pillar, partly delimiting a wheel arch designed to accommodate a wheel, the front hinge pillar being composed of at least one assembly of at least two sheet-metal parts together forming a junction rabbet extending into the wheel arch, the sheet-metal parts being joined together by a plurality of welding points located on the junction rabbet, the body comprising a reinforcement part attached to the front hinge pillar and arranged between the front hinge pillar and a wheel housed in the wheel arch, the reinforcement part being designed to reinforce the front hinge pillar and prevent the rabbet from opening in the event of a frontal impact, the reinforcement part covering part of the front hinge pillar and extending on either side of the junction rabbet, the junction rabbet having a plurality of projections extending into the wheel arch and intended to receive the welding points, the reinforcement part having a plurality of openings located in line with each projection and dimensioned to allow each projection to pass through an opening, when the reinforcement part is attached to the front hinge pillar.

The described devices lastly relate to a motor vehicle comprising a body.

Thus, the body has a front hinge pillar with a rabbet. The reinforcement part is designed to protect the rabbet in the event of a low-overlap frontal impact, so that the impact of the wheel on the rabbet presents little or no risk of causing the rabbet to separate. The presence of projections on the rabbet to accommodate the welding points ensures that the front hinge pillar is adequately secured, while limiting the extension of the rabbet to the projections. The openings made in the reinforcement part in line with the projections, when the reinforcement part is attached to the front hinge pillar, help to limit the footprint of the front hinge pillar and the reinforcement part, since the passage of the projections through the openings enables the reinforcement part to be positioned as close as possible to the front hinge pillar. In this way, the reinforcement part frees up space in the wheel arch for a larger wheel than with a conventional reinforcement.

According to one embodiment, the reinforcement part is screwed into the front hinge pillar.

Advantageously, the reinforcement part is further attached to a firewall cross-member.

According to one option, the reinforcement part is made of a stamped metal sheet.

According to one embodiment, the openings are aligned and each has an oblong shape.

According to one option, the reinforcement part forms a step.

Advantageously, the step is reinforced by at least one rib.

According to one option, the projections of the rabbet form a serration.

### BRIEF DESCRIPTION OF THE FIGURES

The described devices will be better understood upon reading the following detailed description, given solely by way of non-limiting example and with reference to the accompanying drawings, wherein:

FIG. 1 shows a detailed perspective view of a front hinge pillar and a reinforcement part of a body;

FIG. 2 shows a detail view of the body shown in FIG. 1, wherein the reinforcement part is not shown in order to show the joint rabbet of the front hinge pillar;

FIG. 3 shows a horizontal cross-section of the front hinge pillar and the reinforcement part, showing a projection in an opening.

In these figures, the same references are used to designate the same elements.

### DETAILED DESCRIPTION

A motor vehicle body 1, as shown in the figures, is intended to provide a vehicle with adequate behavior in the event of a low-overlap frontal impact.

The vehicle body 1 thus comprises at least one hollow front hinge pillar 2, forming a generally vertical profile and partly delimiting a wheel arch 3 designed to accommodate a wheel, not shown in the figures.

The front hinge pillar 2 is at least partly composed of an assembly 4 of at least two sheet-metal parts 5 together forming a junction rabbet 6. The rabbet 6 extends into the wheel arch 3, the sheet-metal parts 5 being joined together by a plurality of welding points 7 located on the junction rabbet 6.

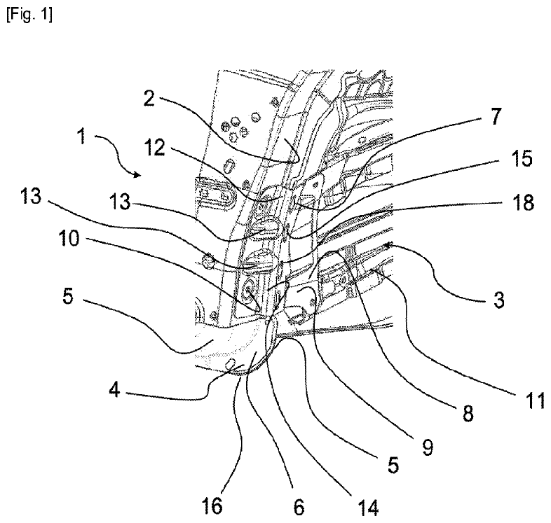

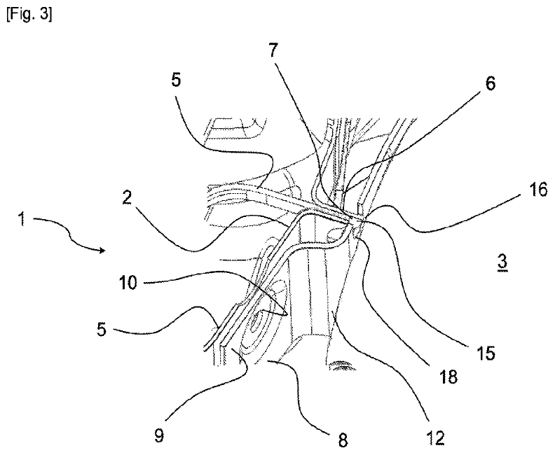

The body 1 further comprises a reinforcement part 8 attached to the front hinge pillar 2 and arranged between the front hinge pillar 2 and a wheel housed in the wheel arch 3. The reinforcement part 8 is designed to reinforce the front hinge pillar 2 and to prevent the rabbet 6 from opening in the event of a frontal impact. In the example shown in FIGS. 1 and 3, the reinforcement part 8 is formed from a stamped metal sheet 9. The reinforcement part 8, for example, is screwed into the front hinge pillar 2, and to this end is provided with at least one screw interface 10. Advantageously, the reinforcement part 8 is also attached to a firewall cross-member 11, as shown in FIG. 1. In addition, as shown in FIG. 3, the reinforcement part 8 forms a step 12 and advantageously the step 12 is reinforced by at least one rib 13, in this case two ribs 13.

The reinforcement part 8 covers part of the front hinge pillar 2 and extends on either side of the junction rabbet 6. A portion 14 of the step 12, for example, is dimensioned to rest on one of the sheet-metal parts 5 and at least partly match the shape of the junction rabbet 6.

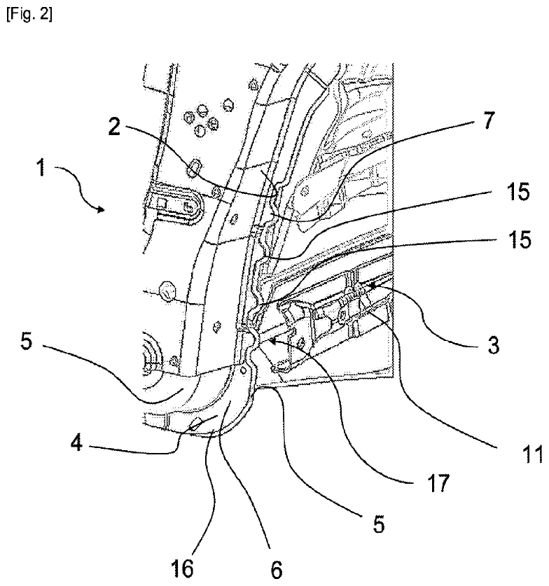

As shown in FIG. 2, where the reinforcement part 8 is omitted for ease of understanding, the junction rabbet 6 has a plurality of projections 15 extending into the wheel arch 3 and intended to receive the welding points 7. Each projection 15 is formed by cutting out a free end 16 of the rabbet 6. Thus, for example, the projections 15 of the rabbet form a serration 17, as shown in FIG. 2. In the embodiment shown in the figures, the junction rabbet 6 is substantially flat and the projections 15 are therefore substantially aligned.

The reinforcement part 8 has a plurality of openings 18, each oblong in shape, located in line with each projection 15 and dimensioned to allow each projection 15 to pass through an opening 18, as shown in FIG. 3, when the reinforcement part 8 is attached to the front hinge pillar 2. The dimensions of each opening 18 are obviously adjusted to match the contour of the corresponding projection 15 as closely as possible.

As shown in FIG. 3, each projection 15 can thus extend through the reinforcement part 8 while allowing the latter to be positioned bearing against at least part of the front hinge pillar 2.

Thus, the vehicle body 1 has a front hinge pillar 2 provided with a junction rabbet 6 protected by the reinforcement part 8. By passing the projections 15 through the openings 18, the reinforcement part 8 can be positioned as close as possible to the sheet-metal parts 5 of the front hinge pillar 2. The reinforcement part 8 reinforces the front hinge pillar 2 to obtain a vehicle with adequate behavior in the event of a low-overlap frontal impact, while allowing the installation of wheels with larger dimensions than with a conventional reinforcement.

The described devices are not limited to the embodiment of the vehicle body described above, only by way of example, but other embodiments can be designed by the person skilled in the art without departing from the frame and scope of the present description.

1. A motor vehicle body comprising at least one front hinge pillar, partly delimiting a wheel arch designed to receive a wheel, the front hinge pillar being composed of at least one assembly of at least two sheet-metal parts together forming a junction rabbet extending into the wheel arch, the sheet-metal parts being joined together by a plurality of welding points located on the junction rabbet, the body comprising a reinforcement part attached to the front hinge pillar and arranged between the front hinge pillar and a wheel housed in the wheel arch, the reinforcement part being designed to reinforce the front hinge pillar and prevent the rabbet from opening in the event of a frontal impact, the reinforcement part covering part of the front hinge pillar and extending on either side of the junction rabbet, the junction rabbet having a plurality of projections extending into the wheel arch and intended to receive the welding points, the reinforcement part having a plurality of openings located in line with each projection and dimensioned to allow each projection to pass through an opening, when the reinforcement part is attached to the front hinge pillar .

2. The vehicle body according to claim 1, wherein the reinforcement part is screwed into the front hinge pillar.

3. The vehicle body according to claim 2, wherein the reinforcement part is further attached to a firewall cross-member.

4. The vehicle body according to claim 1, wherein the reinforcement part is formed from a stamped metal sheet.

5. The vehicle body according to claim 1, wherein the openings are aligned and each have an oblong shape.

6. The vehicle body according to claim 1, wherein the reinforcement part forms a step.

7. The vehicle body according to claim 6, wherein the step is reinforced by at least one rib.

8. The vehicle body according to claim 1, wherein the projections of the rabbet form a serration.

9. A motor vehicle comprising a body according to claim 1.
